(19) United States
(12) Patent Application Publication
(10) Pub. No.: US 2012/0112018 A1
(43) Pub. Date: May 10, 2012

(54) Magnetic-electric toothbrush holder

(75) Inventors: Heather Jayne Barry, Santa Clara, CA (US); Nadeem Akhtar, Santa Clara, CA (US)

(73) Assignee: Heather Jayne Barry, Santa Clara, CA (US)

(21) Appl. No.: 12/927,069

(22) Filed: Nov. 5, 2010

(51) Int. Cl. F16M 11/04; H01F 7/02

(52) U.S. Cl. 248/121; 248/206.5

(57) ABSTRACT

A hygienic magnetic-electric toothbrush holder capable of suspending one or more electric toothbrushes, without prejudice to brand or housing style. The present invention is based on the fact that all electric toothbrushes internally consist of parts which are made with iron, steel, or alloys of these metals, which attach through the plastic housing of the electric toothbrush, to an external magnet. The present invention is designed with a magnet for the suspension and a second magnet for the prevention of lateral movement, of the electric toothbrush. The magnets are coated, on the front flat surface, with a non-slip material to prevent sliding of the electric toothbrush. The present invention may be attached to a base unit for the countertop. The present invention may be made of plastic, metal, ceramic, or other hygienic water-proof material. The design of the present invention allows for easy cleaning and inspection to ensure hygienic cleanliness.

### FIELD OF INVENTION

This invention relates to magnetic holding devices and more particularly to electric toothbrush holders.

### BACKGROUND

Electric toothbrushes are becoming more popular among consumers; therefore it is necessary that people have a neat, hygienic and affordable way to store the electric toothbrush when it is not in use. Currently electric toothbrushes are stored by laying them flat on countertops or in storage containers, or by placing them vertically in cup-type holders. Because the electric toothbrush is wet when placed on the countertop or in the container, and the bristles are not prevented from touching these surfaces, bacteria will cross contaminate from the countertop or storage container to the electric toothbrush, and then to the consumer. Many consumers place the electric toothbrush in a cup-type holder this manner of storage also allows for the spread of bacteria that grows in the bottom of the cup, and allows for contact with other toothbrushes stored in the same cup-type holder. Also considering weight and size of many of the electric toothbrushes this method of storage is not always a stable option.

The UV style toothbrush holders cannot accommodate for the array of different electric toothbrush models, they are enclosed and do not allow the brush to dry, are expensive, and are not practical for children.

Furthermore many people who have small bathrooms with pedestal sinks or small sinks with little counter space, need to use a wall-mount holder. Currently wall-mount toothbrush holders cannot accommodate for the array of different electric toothbrush housings. They also allow for the spread of bacteria that grows in the bottom service where the handle sits.

Accordingly there is not a hygienic, aesthetically pleasing and affordable way to properly hold the electric toothbrush when it is not in use.

### SUMMARY

Therefore it is general object of this invention to provide the consumer with a hygienic, aesthetically pleasing, practical, affordable and fun, magnetic-electric toothbrush holding device. The electric toothbrush will be suspended from a single magnet and stabilized with a secondary magnet

It is an object of this invention to magnetically suspend the electric toothbrush, keeping the electric toothbrush in a vertical position allowing the bristles to air dry completely without contact and contamination from foreign objects.

It is an object of the present invention to magnetically suspend one or more electric toothbrushes, with a minimal amount of physical contact to the electric toothbrush.

It is an object of the present invention to magnetically suspend the electric toothbrush above a countertop, sink, drip catch, base or other surface which is below but not in contact with the electric toothbrush, thus allowing the water to drip off and allowing the handle to dry completely. The electric toothbrush will not be in contact with the stagnant water or sediment that is present in cup-type holders and other containers, further reducing the possibility of contamination to the electric toothbrush.

It is an object of the present invention to magnetically suspend the electric toothbrush in a manner in which the electric toothbrush may be easily removed or replaced.

It is an object of the present invention to magnetically suspend any electric toothbrush without prejudice to housing style or brand.

It is an object of the present invention to magnetically suspend a single electric toothbrush or multiple electric toothbrushes. The number of electric toothbrushes the present invention may suspend is proportionately dependent upon the number of magnetic-suspension piece and magnetic-stability piece sets. Each electric toothbrush requires one magnetic-suspension piece and one magnetic stability-piece.

It is an object of the present invention to magnetically suspend multiple electric toothbrushes in a manner which they do not make contact with each other.

It is an object of the present invention to magnetically suspend the electric toothbrush, as described, on a freestanding base unit for countertop placement. The support piece and base combined create the base unit. This base unit must be of a size, shape, and weight to accommodate the number of electric toothbrushes that the magnetic-electric toothbrush holder is suspending. The base unit must be of a size, shape, and weight so that the magnetic-electric toothbrush holder is stable when an electric toothbrush is removed or replaced. This base unit can be a variety of shapes, sizes and or themed, including but not limited to pyramid, square, rectangle, animal forms, character forms etc. for aesthetic appeal.

It is an object of the present invention to magnetically suspend the electric toothbrush as described in a wall-mount alternative. The vertical-mounting piece, to which the magnetic-suspension piece and magnetic-stabilizing piece are mounted, in this wall-mount alternative, will have a relatively flat back surface. An adhesive tape or other adhesive or may be used to attach the magnetic electric toothbrush holder to a wall mirror or other preferably vertical surface. The vertical mounting piece can be a variety of shapes and sizes or themed, including but not limited to triangle, square, rectangle, animal forms, character forms etc, for aesthetic appeal.

Other objects, features and advantages of the present invention will become more apparent through a review of the drawings and the following detailed description of the preferred embodiment.

### BRIEF DESCRIPTION OF THE DRAWINGS

FIG. 1 is a right-side elevated view of the freestanding magnetic-electric toothbrush holder;

FIG. 2 is a cross-sectional side-view of the magnetic-suspension piece and magnetic-stabilizing piece;

FIG. 3 is a front-elevated view of the freestanding magnetic-electric toothbrush holder;

FIG. 4 is a bottom view of the base;

FIG. 5 is a front view of the freestanding designed to support three electric toothbrushes embodying principles of the present invention;

FIG. 6 is a right-side view of the wall-mount magnetic-electric toothbrush holder, with a removable drip catch;

FIG. 7 is a top view of the removable drip catch;

FIG. 8 is a bottom view of the wall-mount magnetic-electric toothbrush holder without the removable drip;

FIG. 9 is a front elevated view of the wall-mount magnetic-electric toothbrush holder with removable drip catch;

FIG. 10 is a back-elevated view of the wall-mount magnetic electric toothbrush holder with removable drip catch;

FIG. 11 illustrates an ornamental design for a freestanding countertop magnetic-electric toothbrush holder;

FIG. 11 illustrates an ornamental design for a wall-mount magnetic-electric toothbrush holder;

The broken-line disclosure of an electric toothbrush in is for illustrative purposes only and forms no part of the claimed design.

### DETAILED DESCRIPTION OF THE PREFERRED EMBODIMENTS

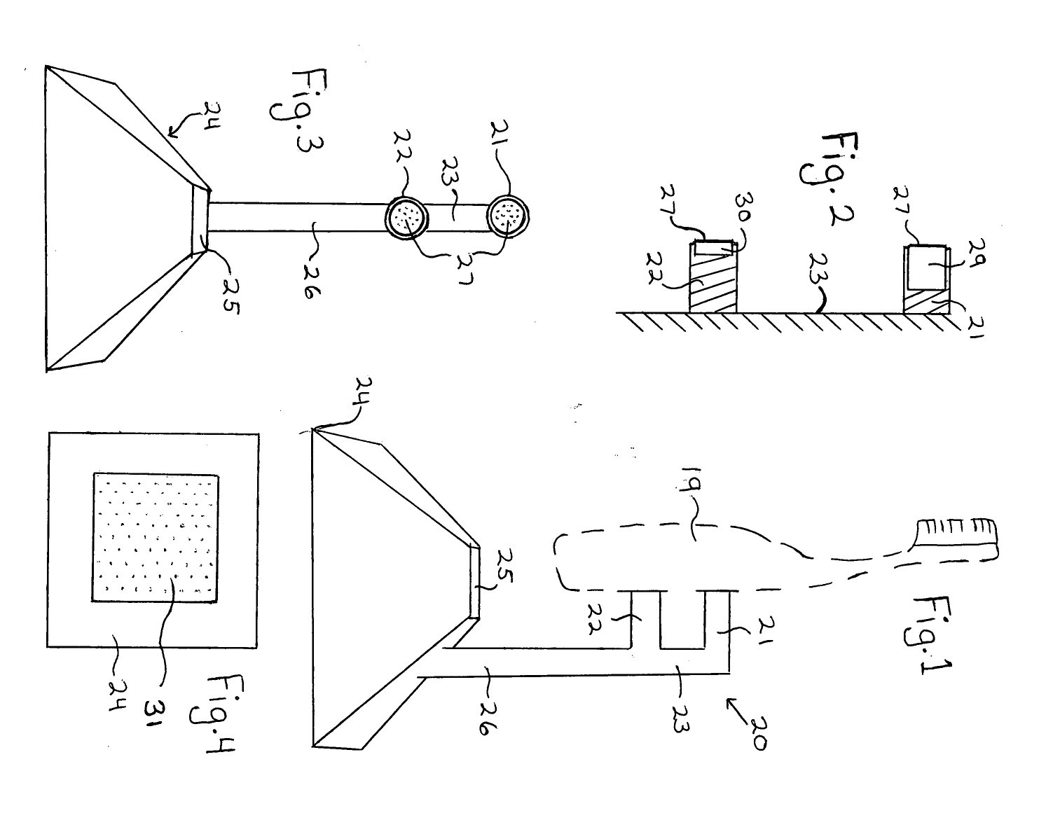

FIG. 1 illustrates the preferred embodiment of the present invention. The invention herein is described as a magnetic-electric toothbrush holder 20. The magnetic-electric toothbrush holder 20, is formed of rigid material such as, but not limited to, plastic, metal, ceramic, or other hygienic waterproof material. The preferred embodiment of the present invention would allow for easy cleaning and inspection to ensure hygienic cleanliness. The magnetic-electric toothbrush holder 20 is primarily comprised of a magnetic-suspension piece 21, a magnetic-stability piece 22 and a vertical-mounting piece 23. The magnetic-suspension piece 21 and the magnetic-stability piece 22 are parallel to each another in a horizontal position, and are molded at ninety-degrees to the vertical-mounting piece 23. The magnetic-suspension piece 21 is mounted directly above with the magnetic-stability piece 22, spaced at a distance which will permit the strongest magnetic pull at the points of contact, with the majority of electric toothbrushes 19, while also providing the most stability. The length of the magnetic-suspension piece 21 and the magnetic-stability piece 22 must be of a length so that they can partially encapsulate the magnet 29 (FIG. 2) and the magnet 30 FIG. 2 respectively, while also allowing for ornamental protrusions as found on many children's caricature electric toothbrushes 19. The vertical-mounting piece 23 must be of a size and shape to accommodate the number of electric toothbrushes 19 the magnetic-electric toothbrush holder 20 will be suspending, while maintaining the objectives of the present invention. The vertical-support piece 26 connects the vertical-mounting piece 23 to the base 24. The vertical-support piece 26 is of a length so that when an electric toothbrush 19 is magnetically suspended in position, it is suspended without touching the base 24. The magnetic-electric toothbrush holder 20 will support an electric toothbrush 19 without prejudice to housing style or brand. In the preferred embodiment of the present invention, the magnetic-suspension piece 21, magnetic-stability piece 22 and vertical-mounting piece 23 are cylindrical in shape. However, for aesthetics they may be formed in any physical shape so long as they embody the principles set forth in the present invention. The vertical-support piece 26 is molded to the base 24. The base 24 with attached vertical-support piece 26 must be of a size, shape and weight to accommodate the number of electric toothbrushes 19 that the magnetic-electric toothbrush holder 20 is suspending. The base 24, with attached vertical-support piece 26, must be of a size, shape and weight so that the magnetic-electric toothbrush holder is stable when an electric toothbrush 19 is removed and replaced. The base 24 in the preferred embodiment would have a slight concave depression 25 on the top surface, directly under the electric toothbrush 19, to capture any water dripping from the electric toothbrush 19. The base 24 and the vertical-support piece 26 can be a variety of sizes and shapes and or themed, including but not limited to, pyramid (as shown), square, rectangle, animal forms, character forms etc. for aesthetic appeal.

FIG. 2 illustrates a cross-sectional side-view of the magnetic-suspension piece 21 and the magnetic-stability piece 22; illustrating, magnet 29 which is partially encapsulated within the magnetic-suspension piece 21, leaving only the front surface of the magnet 29 exposed, and magnet 30 which is partially encapsulated within the magnetic-stability piece 22, leaving only the front surface of the magnet 30 exposed. This magnet 29 will be a small high-strength magnet which can suspend the weight of the electric toothbrush 19. The magnet 30 will be a smaller high-strength magnet; its purpose is to prevent the electric toothbrush 19 from rotating on the axis point of the magnet 29, thereby preventing lateral movement of the electric toothbrush 19 thus preventing the electric toothbrush 19 for being easily dislodged, and holding it in a vertical position.

FIG. 2-3 illustrate that the exposed front surfaces of magnet 29 and magnet 30, have a non-slip coating 27. The pull-force of magnet 29 and magnet 30 are affected by various factors which include the weight of the electric toothbrush 19, the coefficient of friction between the magnet 29, magnet 30, and the electric toothbrush's 19 housing. Since most electric toothbrush's 19 housings are made of smooth plastic, it is necessary to increase the coefficient of friction at the contact point between the surfaces of the magnet 29, magnet 30, and the electric toothbrush 19, thus preventing the electric toothbrush 19 from sliding down. The coefficient will be increased by adding a non-slip coating 27, to the front surface of both magnet 29 and magnet 30.

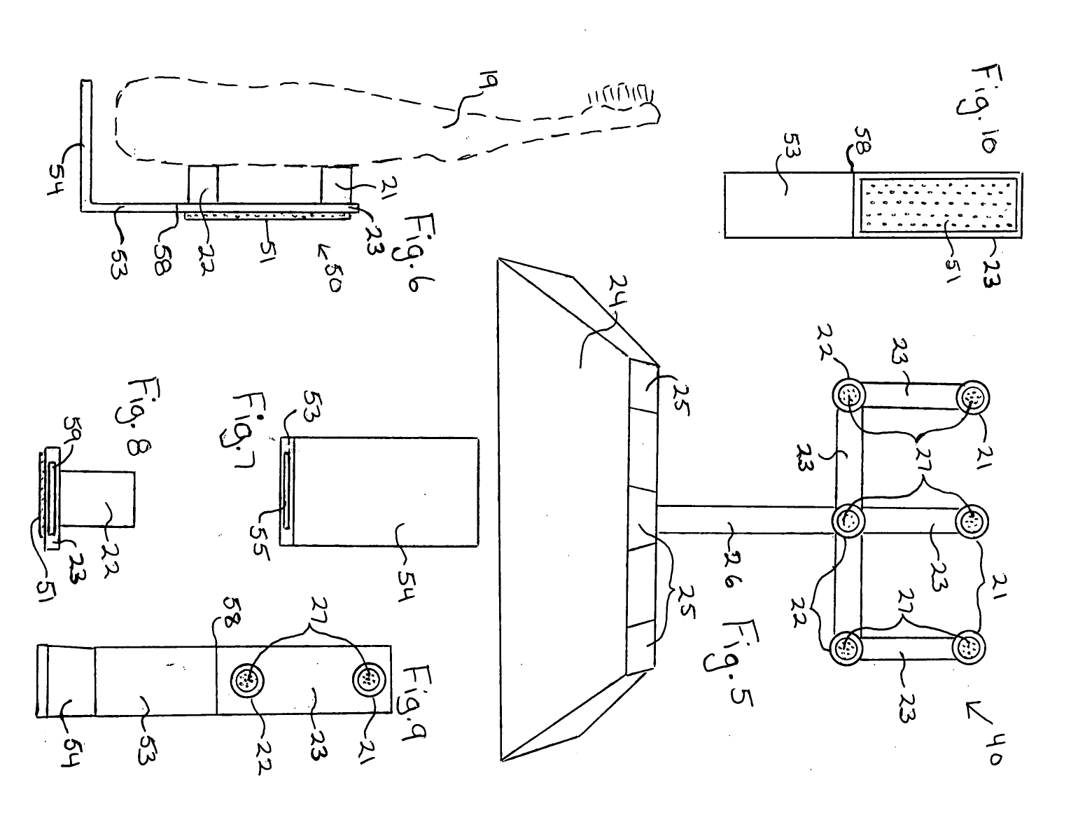

FIG. 4 illustrates the bottom surface of the base 24; since the base 24 can be a variety of shapes and sizes this will vary according to the design. However it is an object of the present invention for the electric toothbrush 19 to be easily removed and replaced. Therefore the preferred embodiment of the present invention has a non-slip material 31 which is on the bottom surface of the base 24. The non-slip material 31 will prevent the electric-toothbrush holder 20 from moving or sliding on the countertop when an electric toothbrush 19 is removed or replaced.

FIG. 5 illustrates a front-elevated view of the magnetic-electric toothbrush holder 20 for the suspension of multiple electric toothbrushes 19 herein described as the second embodiment 40. This embodies the principles of the present invention, expanded to hold three electric toothbrushes 19. The second embodiment 40 may suspend several electric-toothbrushes 19, for illustration purpose the second embodiment 40 has been designed to suspend three electric toothbrushes 19. The number of electric toothbrushes 19 the second embodiment 40 may actually suspend are proportionately dependent upon the number of magnetic-suspension piece 21, and magnetic stability piece 22 sets. All the magnetic-suspension pieces 21 and all the magnetic stability pieces 22, must have a non-slip coating 27 on the front surface of the partially encapsulated magnets 29 and magnets 30, respectively FIG. 2. Each electric toothbrush 19 requires one magnetic-suspension piece 21, and one magnetic-stability piece 22. The vertical-mounting piece 23 must be of a size and shape to accommodate the number of electric toothbrushes 19 the magnetic-electric toothbrush holder 20 will be suspending, while maintaining the objectives of the present invention. The pairs, of magnetic-suspension piece 21 and magnetic-stability piece 22 for each electric toothbrush 19, must be spaced apart from one another so that when one electric toothbrush 19 is removed or replaced, in regular use, the other electric toothbrushes 19 which are being suspended, are not disturbed. The length of the vertical-mounting piece 23 may vary for aesthetic appeal however the placement of the magnetic-suspension piece 21 and the magnetic-stability piece 22 to the vertical-mounting piece 23 must maintain the principles and objectives of the present invention. In the preferred design of the second embodiment 40 the vertical-mounting piece 23 is four cylinder rods molded together. The vertical-support piece 26 connects the vertical-mounting piece 23 to the base 24. The vertical-support piece 26 is of a minimum length so that when an electric toothbrush 19 is magnetically held in position, it is suspended without touching the base 24. The base 24 in the preferred second embodiment 40 would have three slight concave depressions 25 on the top surface, directly under each electric toothbrush 19, to capture any water dripping from the electric toothbrush 19. In the preferred design, of the second embodiment 40, the base 24 with attached vertical-support piece 26, must be of a size, shape and weight to accommodate the number of electric toothbrushes 19 that the second embodiment 40 of the magnetic-electric toothbrush holder 20 is suspending. In the preferred design, of the second embodiment 40, the base 24 with attached vertical-support piece 26, must be of a size, shape and weight so that the second embodiment 40 of the magnetic electric toothbrush holder 40 is stable when an electric toothbrush 19 is removed and replaced. This base 24 and the vertical-support piece 26 may be a variety of shapes and sizes or themed for aesthetic appeal, as is illustrated in FIG. 11 for the suspension of a single electric toothbrush 19, the same can be done with the second embodiment 40 of the present invention.

FIG. 6 illustrates an elevated right-side view of the preferred third embodiment, the wall-mounted magnetic-electric toothbrush holder 50. The wall-mounted magnetic toothbrush holder 50 embodies the principles of the present invention 20; differing only in the fact that the back-side of the vertical-mounting piece 23 must be relatively flat. In use the wall-mounted magnetic-electric toothbrush holder 50 is preferably, but not necessarily, affixed to a vertical relatively flat surface using an adhesive or adhesive tape 51 which is applied to the back surface of the vertical-mounting piece 23. Below the suspended-electric toothbrush 19 is an optional drip catch 54 which is molded at a right angle to a vertical-mounting extender piece 53. The vertical-mounting piece extender 53 will be attached to the vertical-mounting piece 23 magnetically at the easy-off connection point 58, thus allowing the user to easily remove and replace the vertical-mounting piece extender 53 with attached drip catch 54 for easy cleaning. The vertical-mounting piece extender 53 will be of a length so that when attached to the vertical-mounting piece 23, the drip catch 54 is below, and not touching, the electric toothbrush 19. The drip catch 54 will be of a length and width so that will cover the area directly under the toothbrush 19, thus catching the water that runs down the handle and drips off the end, preventing unwanted water on the counter or other surface below.

FIG. 7 illustrates the wall-mounted magnetic-electric toothbrush holder's 50 optional vertical-mounting piece extender 53 with attached drip catch 54. A thin, flat, nickel plated (to prevent rust) magnet 55 is attached to the top edge of the vertical-mounting piece extender 53.

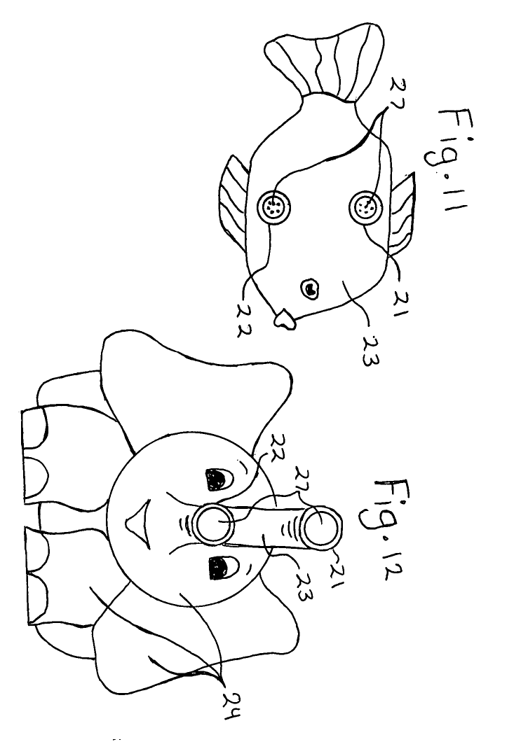

FIG. 8 illustrates a thin, flat, nickel plated (to prevent rust) magnet 56 which is attached to the bottom edge of the vertical-mounting piece 23, of the preferred embodiment of the wall-mounted magnetic-electrical toothbrush holder 50.

FIG. 9 illustrates an elevated-front view of the preferred embodiment of the wall-mounted magnetic-electric toothbrush holder 50. In this illustration the vertical-mounting piece 23 is a rectangle, however, the vertical-mounting piece 23 may be a variety of shapes and sizes or themed, including but not limited to, triangle, square, animal forms, character forms etc, for aesthetic appeal as illustrated in FIG. 10. As in the countertop magnetic-electric toothbrush holder 20, the wall-mounted magnetic-electric toothbrush holder 50 will have non-slip coating 27 on the front surfaces of both magnet 29 and magnet 30. The preferred embodiment of the wall-mounted magnetic-electric toothbrush holder 50 may be designed to suspend multiple-electric toothbrushes 19 by increasing the number of magnetic-suspension pieces 21 and the number of magnetic-stability pieces 22 proportionately (each electric toothbrush requires one magnetic-suspension piece 21 and one magnetic-stability piece 22) and by increasing the size of the vertical-mounting piece. The pairs, of magnetic-suspension piece 21 and magnetic-stability piece 22, for each electric toothbrush 19 must be spaced apart from one another so that when one electric toothbrush 19 is removed or replaced, in regular use, the other electric toothbrushes 19, which are being suspended are not disturbed.

FIG. 10 illustrates the back-view of the wall-mounted magnetic-electric toothbrush holder 50. The back-side of the vertical-mounting piece 23 is relatively flat so that the adhesive material or adhesive tape 51 makes secure contact between the vertical-mounting piece 23 and the surface to which it is being attached, thus preventing the wall-mounted magnetic-electric toothbrush holder 50 from being detached from the mounting surface (example a wall or mirror), when the electric toothbrush 19 is removed.

FIG. 11 illustrates the wall-mounted magnetic-electric toothbrush holder using an alternative ornamental shape for the vertical-mounting piece 23. The vertical-mounting piece 23 may be a variety of shapes, and sizes and themed for aesthetic appeal, providing that the vertical-mounting piece upholds the objectives of the present invention.

FIG. 12 illustrates the magnetic-electric toothbrush holder 20 using an alternative ornamental base 24. The ornamental base 24 may be a variety of shapes, and sizes and or themed for aesthetic appeal, providing that the base 24 upholds the objectives of the present invention.

We claim:

1. A magnetic-electric toothbrush holder comprising at least one: magnet A, magnet B, suspension piece, stability piece, and vertical-mounting piece for magnetically suspending, preventing lateral movement and maintaining vertical placement of an electric toothbrush;
said magnet A and said magnet B are small high strength magnets;
front surface of said magnet A and front surface of said magnet B are on the same vertical plane;
front surface of said magnet A and front surface of said magnet B have a non-slip coating;
said magnet A is positioned directly above said magnet B;
said magnet A is at least partially encapsulated in end part of said suspension piece;
said suspension piece holds magnet A in a horizontal position;
said magnet B is at least partially encapsulated in end part of said stability piece;
said stability piece holds magnet B in a horizontal position;
said suspension piece is attached to said vertical-mounting piece;
said stability piece is attached to said vertical-mounting piece;
said suspension piece, said stability piece, and said vertical-mounting piece are made from plastic, metal, ceramic, or other hygienic water-proof material.

2. A magnetic-electric toothbrush holder according to claim 1 wherein said vertical-mounting piece has a relatively flat-back surface to allow said magnetic-electric toothbrush holder to be affixed to a relatively flat surface, such as but not limited to a wall or mirror;

3. A magnetic-electric toothbrush holder, according to claim 1, adapted for countertop placement further comprises a vertical-support piece and a base;
said vertical-support piece is attached vertically to said base;
said vertical-mounting piece, as defined in claim 1, is attached to said vertical-support piece;
said vertical-mounting piece is attached to said vertical-support piece such that the positioning of said magnet A and said magnet B is in accordance with claim 1;
said vertical-support piece and said base are made from plastic, metal, ceramic, or other hygienic water-proof material.

4. A magnetic-electric toothbrush holder, according to claim 4, wherein said base has a non-slip coating on the bottom surface, to maintain counter placement of said magnetic-electric toothbrush holder when said electric toothbrush is removed and replaced;

5. A magnetic-electric toothbrush holder according to claim 4 wherein said base is heavy enough so that the force required removing said electric toothbrush from said magnet A and said magnet B will not move said base from its placement.
